(19) United States
(12) Patent Application Publication
(10) Pub. No.: US 2025/0007122 A1
(43) Pub. Date: Jan. 2, 2025

(54) SECONDARY BATTERY AND BATTERY MODULE INCLUDING THE SAME

(71) Applicant: Samsung SDI Co., Ltd., Yongin-si (KR)

(72) Inventors: Jung Soo KIM, Yongin-si (KR); Jun Sun YONG, Yongin-si (KR); Kwang Soo BAE, Yongin-si (KR); Jun Hyung LEE, Yongin-si (KR)

(21) Appl. No.: 18/607,182

(22) Filed: Mar. 15, 2024

(30) Foreign Application Priority Data
Jun. 28, 2023 (KR) 10-2023-0083457

(51) Int. Cl. H01M 50/553; H01M 50/15; H01M 50/176; H01M 50/209; H01M 50/503; H01M 50/516; H01M 50/528; H01M 50/531

(52) U.S. Cl. CPC H01M 50/553; H01M 50/15; H01M 50/176; H01M 50/209; H01M 50/503; H01M 50/516; H01M 50/528; H01M 50/531

(57) ABSTRACT

A secondary battery includes: an electrode assembly including a first electrode tab and a second electrode tab exposed at opposite sides thereof; a first collector electrically coupled to the first electrode tab; a case having two open sides and accommodating the electrode assembly and the first collector therein; a first cap plate sealing one of the open sides of the case; and a first terminal mechanically and electrically coupled to the first collector and exposed to the outside of the first cap plate. The first terminal includes: a first terminal plate at a side of the first collector; and a first protrusion vertically protruding from a top surface of the first terminal plate to the outside of the first cap plate.

### CROSS-REFERENCE TO RELATED APPLICATION

The present application claims priority to and the benefit of Korean Patent Application No. 10-2023-0083457, filed on Jun. 28, 2023, in the Korean Intellectual Property Office, the entire disclosure of which is incorporated herein by reference.

### BACKGROUND

### 1. Field

Aspects of embodiments of the present disclosure relate to a secondary battery and a battery module including the same.

### 2. Description of the Related Art

A secondary battery is a power storage system that provides excellent energy density by converting electrical energy into chemical energy and storing the chemical energy. Compared to non-rechargeable (or primary) batteries, secondary batteries are designed to be rechargeable and are widely used to power IT devices, such as smartphones, cellular phones, laptops, tablet PCs, and the like.

In recent years, interest in electric vehicles has increased to prevent environmental pollution, and accordingly, high-capacity secondary batteries are being adopted for the electric vehicles. Such secondary batteries desirably have certain characteristics, such as high density, high output, and stability.

Secondary batteries may be made larger in size or longer in one direction for higher output, but there are limitations to increasing size and length. For this, a plurality of secondary batteries may be connected to a busbar. In such cases, terminals of adjacent secondary batteries may be connected to the busbar by welding.

The above-described information provides the background of the present disclosure and is for improving understanding of the background of the present disclosure. Thus, it may include information that does not constitute the related (or prior) art.

### SUMMARY

Embodiments of the present disclosure provide a secondary battery capable of improving weldability between a terminal and a busbar and a battery module including the same.

According to an embodiment of the present disclosure, a secondary battery includes: an electrode assembly including a first electrode tab and a second electrode tab exposed at opposite sides thereof; a first collector electrically coupled to the first electrode tab; a case having two open sides and accommodating the electrode assembly and the first collector therein; a first cap plate sealing one of the open sides of the case; and a first terminal mechanically and electrically coupled to the first collector and exposed to the outside of the first cap plate. The first terminal includes: a first terminal plate at a side of the first collector; and a first protrusion vertically protruding from a top surface of the first terminal plate to the outside of the first cap plate.

The first protrusion may be one projection.

The first protrusion may be a plurality of projections.

The projections of the first protrusion may have the same shape.

The first protrusion may be bent in a direction of the first cap plate.

A guide hole may be defined in a central area of the first protrusion.

The first terminal plate may have a square shape or a circular shape.

The first terminal plate may have a groove for welding with the first collector.

The first protrusion may have a protruding length in a range of about 15 mm to about 50 mm.

According to another embodiment of the present disclosure, a battery module includes: a first secondary battery and a second secondary battery adjacent to each other and having the same structure; and a busbar electrically connecting the first and second secondary batteries to each other. Each of the first secondary battery and the second secondary battery includes: an electrode assembly including a first electrode tab and a second electrode tab exposed to opposite sides thereof; first and second collectors electrically coupled to the first and second electrode tabs, respectively; a case accommodating the electrode assembly and the first and second collectors, the case having opposite open sides; a first cap plate sealing one of the open sides of the case and a second cap plate sealing an opening of the other one of the open sides of the case; and first and second terminals mechanically and electrically coupled to the first and second collectors and exposed to the outside of the first and second cap plates, respectively. The first and second terminals respectively include first and second terminal plates at sides of the first and second collectors and first and second protrusions vertically protruding from top surfaces of the first and second terminal plates to the outside of the first and second cap plates. The busbar is coupled to the first protrusion of the first secondary battery and the second protrusion of the second secondary battery.

The busbar may have coupling areas at opposite ends thereof and respectively coupled to the first and second protrusions and a connection area between the coupling areas.

Each of the first and second protrusions may have a guide hole in a central area thereof, and each of the coupling areas of the busbar may have a hole to correspond to the guide hole in each of the first and second protrusions.

Each of the first and second protrusions may have a welding area for welding with the coupling area of the busbar.

A welding process with the busbar may be performed on outer surfaces of the first and second protrusions.

Each of the first and second protrusions may be one projection, and the busbar may be connected to and extend between a projection of the first protrusion and a projection of the second protrusion.

The first and second protrusions may be bent in a direction of the first and second cap plate, respectively, and the busbar may be bent to be on bottom surfaces of the first and second protrusions or one busbar may be bent to be on top surfaces of the first and second protrusions.

Each of the first and second protrusions may include a plurality of projections, and the busbar may include a plurality of busbars connected to the projections of the first protrusions and the projections of the second protrusions, respectively.

The busbars may be coupled to a surface opposite to a surface on which the projections of the first and second protrusions face each other.

After the first and second protrusions and the busbar are welded, the first and second protrusions may be bent toward the first and second cap plates, respectively.

The first and second protrusions may be bent in a direction in which the projections face each other.

The projections of the first and second protrusions may be bent outwardly.

The projections of the first and second protrusions may be bent in the same direction.

The first secondary battery and the second secondary battery may be connected in series or parallel through the busbar. The first protrusion may have a protruding length in a range of about 15 mm to about 50 mm.

### BRIEF DESCRIPTION OF DRAWINGS

The accompanying drawings are included to provide a further understanding of the present disclosure and are incorporated in and constitute a part of this specification. The drawings illustrate embodiments of the present disclosure and, together with the description, describe aspects and features of the present disclosure. In the drawings:

FIG. 1 is a perspective view of a secondary battery according to embodiments;

FIG. 2 is a cross-sectional view taken along the line A-A′ of the secondary battery shown in FIG. 1;

FIG. 3 is an enlarged partial cross-sectional view of the portion 3 in FIG. 2;

FIG. 4 is an enlarged perspective view of a terminal portion of the secondary battery according to embodiments;

FIG. 5 is a perspective view of a circular terminal plate according to embodiments;

FIG. 6 is a view of a terminal having one projection of a secondary battery according to embodiments;

FIG. 7 is a view of a terminal in which a protrusion of the secondary battery is bent according to embodiments;

FIG. 8 is a perspective view of a battery module including the secondary batteries shown in FIG. 1 according to embodiments; and

FIGS. 9a to 9c show a bent terminal of the battery module according to embodiments.

### DETAILED DESCRIPTION

Embodiments of the present disclosure may, however, be embodied in many different forms and should not be construed as being limited to the embodiments set forth herein. Rather, these embodiments are provided so that this disclosure will be thorough and complete and will fully convey the scope of the present disclosure to those skilled in the art.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Hereinafter, embodiments will be described in detail with reference to the accompanying drawings. Embodiments of the present disclosure will be described in detail with reference to the accompanying drawings so that those skilled in the art can easily implement the present disclosure.

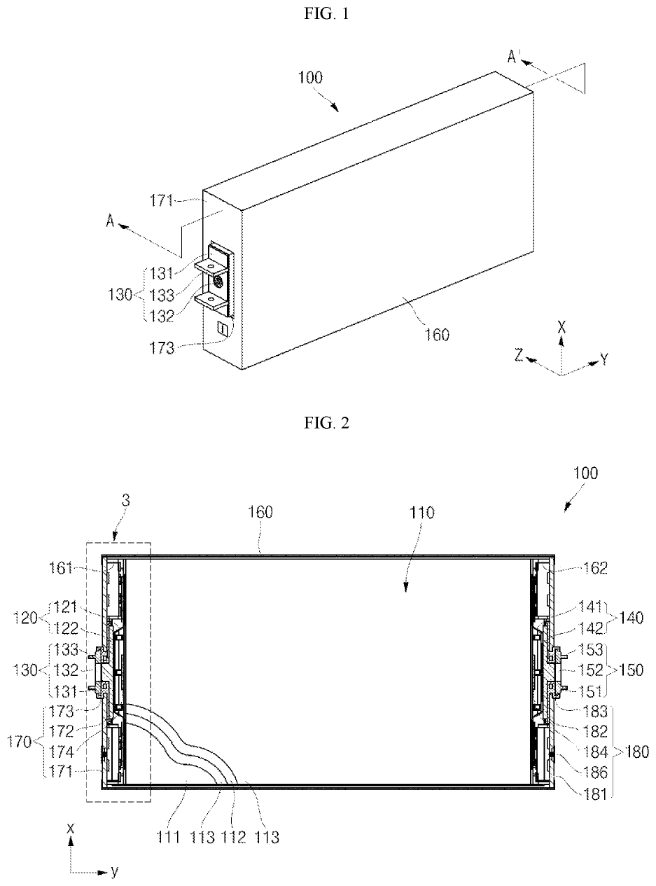

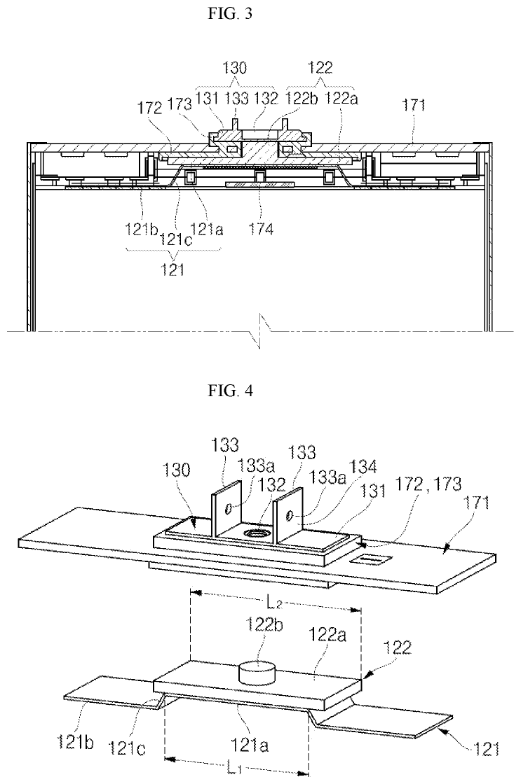

FIG. 1 is a perspective view of a secondary battery according to embodiments, FIG. 2 is a cross-sectional view taken along the line A-A′ of the secondary battery shown in FIG. 1, and FIG. 3 is an enlarged partial cross-sectional view of the portion 3 in FIG. 2. Hereinafter, a secondary battery, according to embodiments of the present disclosure, will be described based on a structure of a secondary battery 100 illustrated in FIG. 1.

As illustrated in FIGS. 1 to 3, the secondary battery 100 may include an electrode assembly 110, a first collector 120, a first terminal 130, a second collector 140, a second terminal 150, a case 160, a first cap assembly 170, and a second cap assembly 180.

The electrode assembly 110 may be provided by winding or stacking a stack of a first electrode plate 111, a separator 113, and a second electrode plate 112, each of which has a thin plate shape or a film shape. When the electrode assembly 110 is a rolled (or wound) stack, a winding axis may be parallel to a longitudinal direction (e.g., the y direction) of the case 160. In some embodiments, the electrode assembly 110 may be a stacking type rather than a winding type, but the shape of the electrode assembly 110 is not limited thereto. In some embodiments, the electrode assembly 110 may be a Z-stack electrode assembly in which the first electrode plate 111 and the second electrode plate 112 are inserted into both sides of the separator 113 that is bent (or folded) in the form of a Z-stack. In some embodiments, the electrode assembly 110 may be stacked so that one or more electrode assemblies 110 are adjacent to each other and accommodated in the case 160. In some embodiments, the number of electrode assemblies 110 may not be limited thereto.

The first electrode plate 111 of the electrode assembly 110 may act as a negative electrode, and the second electrode plate 112 may act as a positive electrode, and vice versa.

The first electrode plate 111 may be formed by applying a first electrode active material, such as graphite or carbon, to a first electrode collector made of a metal foil, such as copper, a copper alloy, nickel, or a nickel alloy. The first electrode plate 111 may include a first electrode tab (or first non-coating portion) that is not coated with the first electrode active material. The first electrode tab may be a passage through which current flows between the first electrode plate 111 and the first collector 120. In some embodiments, the first electrode tab may be provided by being cut in advance to protrude from one side when the first electrode plate 111 is manufactured and may protrude more to one side than the separator 113 (e.g., may protrude beyond the separator 113) without separate cutting.

The second electrode plate 112 may be formed by applying a second electrode active material, such as a transition metal oxide, to a second electrode collector made of metal foil, such as aluminum or an aluminum alloy. The second electrode plate 112 may include a second electrode tab (or second non-coating portion) that is not coated with the second electrode active material. The second electrode tab may be a passage through which current flow between the second electrode plate 112 and the second collector 140. In some embodiments, the second electrode tab may be provided by being cut in advance to protrude to the other side when the second electrode plate 112 is manufactured and may protrude more to the other side than the separator 113 (e.g., may protrude beyond the separator 113) without separate cutting.

In some embodiments, the first electrode tab may be disposed on a side surface of a left end of the electrode assembly 110, and the second electrode tab may be disposed on a side surface of a right end of the electrode assembly 110. As used herein, the left and right sides are for convenience of explanation based on the orientation of the secondary battery 100 as illustrated in FIGS. 1 and 2, and the orientation of the secondary battery 100 may be changed if the secondary battery 100 is rotated left and right or up and down. Hereinafter, each component will be described based on the orientation of the secondary battery 100 as illustrated in FIGS. 1 to 3.

In some embodiments, the separator 113 may be disposed between the first electrode plate 111 and the second electrode plate 112 to prevent short circuit while enabling the movement of lithium ions therebetween and may include polyethylene, polypropylene, or a composite film of polyethylene and polypropylene. In some embodiments, the separator 113 may be replaced with an inorganic solid electrolyte, such as sulfide, oxide, or a phosphate compound, which does not require a liquid or gel electrolyte.

The first electrode tab of the first electrode plate 111 and the second electrode tab of the second electrode plate 112 may be respectively disposed on both ends of the electrode assembly 110, as described above. In some embodiments, the electrode assembly 110 may be accommodated in the case 160 together with an electrolyte. In some embodiments, the electrolyte may include an organic solvent, such as EC, PC, DEC, EMC, or DMC, and lithium salt, such as LiPF₆ or LiBF₄. In some embodiments, the electrolyte may be in a liquid or a gel phase. In some embodiments, when an inorganic-based solid electrolyte is used, the electrolyte may be omitted.

In addition, in the electrode assembly 110, the first collector 120 and the second collector 140 may be welded and connected to the first electrode tab of the first electrode plate 111 and the second electrode tab of the second electrode plate 112, which are exposed to both the sides, respectively.

The first collector 120 may be made of a metal and may electrically connect the first electrode plate 111 and the first terminal 130 to each other. In some embodiments, the first collector 120 may be accommodated inside the case 160 and disposed between a first cap plate 171 and the electrode assembly 110.

The first collector 120 may include a first collector plate (e.g., a first collector) 121 that is in contact with and coupled to the first electrode tab (e.g., the non-coating portion) of the first electrode plate 111 and a second collector plate (e.g., a second collector) 122 that is in contact with and coupled to the first terminal 130. The first collector plate 121 and the second collector plate 122 may be integrally provided or separably provided. The first collector 120 may be made of copper or a copper alloy.

The first collector plate 121 may extend in a first direction (e.g., the x direction), which is a longitudinal direction of the first cap plate 171 that is over one surface of the electrode assembly 110 and may have a substantially plate shape. The first collector plate 121 may have the same polarity as the first electrode plate 111 by being coupled through the welding in the state of being in contact with the first electrode tab exposed to one end of the electrode assembly 110.

The first collector 121 may include a central portion 121a having a central area protruding outwardly and edge portions 121b extending in both directions from the central portion 121a. An outer surface of the central portion 121a may be coupled to an inner side of the second collector 122 by welding. The inner surface of the edge portion 121b may be welded and coupled to the first electrode tab of the electrode assembly 110. Compared to the edge portion 121b, the central portion 121a may protrude in an outwardly (or upwardly) direction in which the first cap plate 171 is disposed. The central portion 121a may be spaced apart from one surface of the electrode assembly 110.

A connection portion 121c bent from the central portion 121a toward the edge portion 121b may be disposed between the central portion 121a and the edge portion 121b. The central portion 121a may be disposed closer to a side of the first cap plate 171 than to the edge portion 121b.

In some embodiments, the first collector 121 may include the connection portion 121c and the edge portion 121b, which are provided at both sides in the first direction with the central portion 121a as a center. In some embodiments, because the first collector 120 is provided to protrude outwardly by the connection portion 121c, a space may be defined inside (or under) the first collector 120. A first glue member 174 may be provided in the space to fix the separator 113 of the electrode assembly 110.

In some embodiments, a size of the central portion 121a of the first collector 121 may be less than that of the inner surface of the second collector 122. In some embodiments, a length L1 of the central portion 121a of the first collector 121 in the first direction may be less than a length L2 of the inner surface of the second collector 122. In some embodiments, an area of the central portion 121a of the first collector 121 may be less than that of the inner surface of the second collector 122.

The second collector 122 may extend in the first direction and may have a substantially plate shape. The second collector plate 122 may be in contact with the outer surface of the first collector plate 121 and may be in contact with and welded to be coupled to the inner surface of the first terminal 130. A size of the inner surface of the second collector plate 122 may be greater than that of the central portion 121a of the first collector plate 121. In some embodiments, the length L2 of the inner surface of the second collector 122 in the first direction may be greater than the length L1 of the central portion 121a of the first collector 121.

The second collector 122 may further include a projection 122b protruding outwardly from a central area 122a of the outer surface. The outer surface of the projection 122b may be coupled to the inner surface of the first terminal 130 by contact and welding.

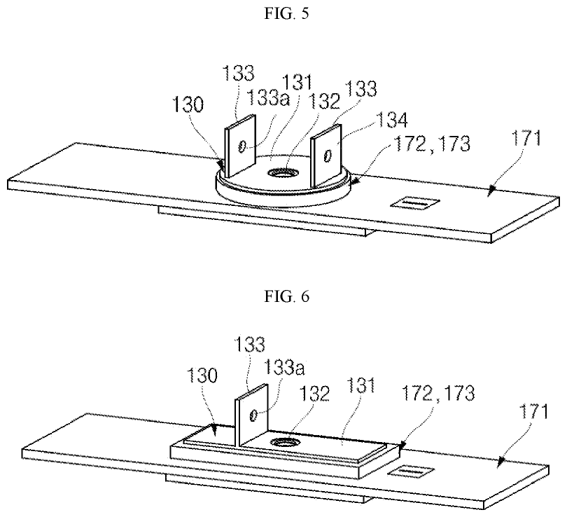

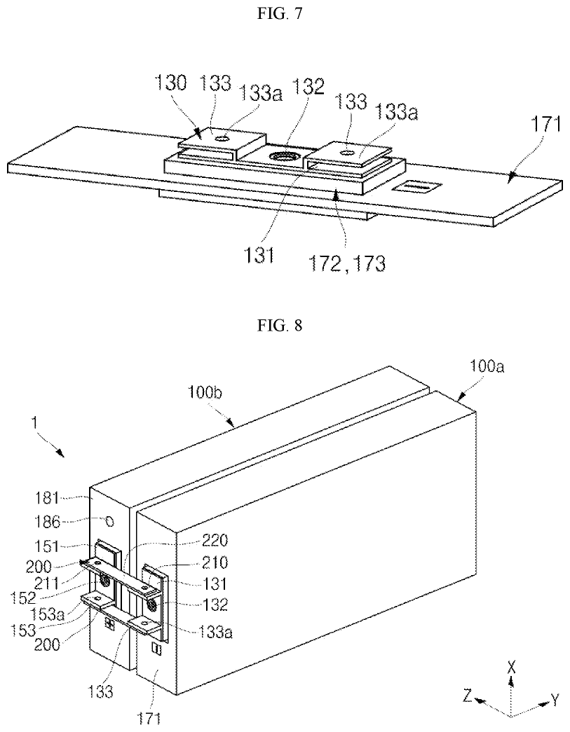

FIG. 4 is an enlarged perspective view of a terminal portion of the secondary battery according to embodiments, FIG. 5 is a perspective view of a circular terminal plate according to embodiments, FIG. 6 is a view of a terminal having one projection according to embodiments, and FIG. 7 is a view of a terminal in which a protrusion is bent according to embodiments. Hereinafter, the first terminal 130 will be described with reference to FIGS. 4 to 7.

The first terminal 130 may be made of a metal and may be electrically connected to the projection 122b by contact and welding. In some embodiments, the first terminal 130 may be formed by a casting or forging method.

The first terminal 130 may be made of aluminum or an aluminum alloy. In some embodiments, when the first terminal 130 is the negative electrode, the first terminal 130 and the first collector 120 may be made of the same metal. However, in some embodiments, the first terminal 130 and the first collector 120 are made of different metals.

In some embodiments, a clad sheet may be further provided between the first terminal 130 and the first collector 120. The clad sheet may couple and electrically connect the first terminal 130 made of different metals to the first collector 120. The clad sheet may be a sheet in which an aluminum sheet and a copper sheet are bonded by thermal compression. For example, the clad sheet may be a sheet in which an aluminum sheet having a thickness of about 2 T and a copper sheet having a thickness in a range of about 0.5 T to about 0.7 T are bonded by thermal compression. The aluminum sheet of the clad sheet may be coupled to the first terminal 130 by welding, and the copper sheet may be coupled to the first collector 120 by welding.

In some embodiments, the first terminal 130 may include a first terminal plate 131, a first terminal groove 132, and a first protrusion 133. The first terminal plate 131 of the first terminal 130 may be exposed and protrude from the outside of the first cap plate 171.

The first terminal plate 131 may be disposed outside or above the first cap plate 171 and may be in contact with and coupled to the second collector plate 122 of the first collector 120 on one side thereof. In some embodiments, the first terminal plate 131 may have a rectangular shape, as illustrated in FIG. 4. However, the present disclosure is not limited thereto, and the first terminal plate 131 may be provided in a circular shape, as illustrated in FIG. 5. In some embodiments, a first seal gasket 173 may have a shape corresponding to the shape of the first terminal plate 131. For example, when the first terminal plate 131 has a circular shape, the first seal gasket 173 may have a corresponding circular shape.

In some embodiments, the first terminal groove 132 may be provided (or formed) inwardly from an outer surface of the first terminal plate 131. In the first terminal plate 131, an area on which the first terminal groove 132 is provided may have a thickness that is less than that of each of other areas. The first terminal plate 131 may be welded to the second collector plate 122 outside the first cap plate 171 through the first terminal groove 132.

The first terminal groove 132 may be defined in a partial area of the first terminal plate 131. The first terminal groove 132 may be defined in a substantially central area of the first terminal plate 131 or in an area corresponding to the projection 122b of the second collector 122.

In some embodiments, the first protrusion 133 may protrude vertically from a top surface of the first terminal plate 131 in an outwardly direction. The first protrusion 133 may have at least two projections, and the at least two projections may have the same shape. However, the present disclosure is not limited thereto, and at least one of the plurality of projections may have different shapes from the other ones, such as a protruding length and thickness.

The protruding length of the first protrusion 133 (e.g., a length from an outer surface of the first terminal plate to an end of the first protrusion) may be in a range of about 15 mm to about 50 mm. If the protruding length of the first protrusion 133 is less than about 15 mm, a welding area with the busbar may not be secured. In some embodiments, if the protruding length of the first protrusion 133 exceeds about 50 mm, energy density (E/D) may not be secured if forming a module/pack.

In some embodiments, a first guide hole (or first guide opening) 133a may be defined in a center area of the first protrusion 133. The first guide hole 133a may act as a guide point for alignment for coupling to the busbar 200, which will be described later. In some embodiments, the first protrusion 133 may be coupled to the busbar 200 by providing a first welding area 134 on an outer surface thereof.

In some embodiments, the number of projections of the first protrusion 133 may be at least two. However, the present disclosure is not limited thereto, and as illustrated in, for example FIG. 6, the number of projections of the first protrusion 133 may be one. In some embodiments, the first protrusion 133 may be provided with at least two projections to secure low resistance and high strength for a high-output cell or rapid charging (e.g., for the application of a large current).

In some embodiments, the first protrusion 133 may be bent in a direction of (e.g., bent to lie flat along or parallel to) the first cap plate 171. Although FIG. 7 illustrates an embodiment in which the first protrusion 133 has two protrusions, which are bent in the outwardly direction, the bending direction of the first protrusion 133 may not be limited thereto. For example, the two projections of the first protrusion 133 may be bent to face each other or may be bent in the same direction.

In some embodiments, a first insulating member 172 may be further disposed between the first terminal plate 131 and the first cap plate 171. In some embodiments, the first seal gasket 173 may be further disposed between the outer surface of the first terminal plate 131 and the first cap plate 171 to seal the space between the first terminal 130 and the first cap plate 171.

The second collector 140 may be made of a metal and may electrically connect the second electrode plate 112 and the second terminal 150 to each other. The second collector 140 may be provided as a metal plate and may include a third collector plate that is in contact with and coupled to the second electrode tab of the second electrode plate 112 and a fourth collector plate 142 that is in contact with and coupled to the second terminal 150. In some embodiments, the second collector 140 may be coupled to the electrode assembly 110 and the second terminal 150 in a shape and configuration that is symmetrical to the first collector 120 with respect to the electrode assembly 110. In some embodiments, the second collector 140 may be made of aluminum or an aluminum alloy.

The second terminal 150 may be made of a metal and may be electrically connected to the second collector 140. In some embodiments, the second terminal 150 may include a second terminal plate 151, a second terminal groove 152, and a second protrusion 153.

In some embodiments, the second terminal plate 151 may be disposed inside a second cap plate 181. In some embodiments, a second insulating member 182 may be further disposed between the second terminal plate 151 and the second cap plate 181. In some embodiments, a second seal gasket 183 may be further disposed between the second terminal plate 151 and the second cap plate 181.

The second terminal 150 may have the same shape and structure as the first terminal 130. However, the second terminal 150 may be coupled to the electrode assembly 110 through the second collector 140 in a shape that is symmetrical to the first terminal 130 with respect to the electrode assembly 110. In some embodiments, the second terminal 150 may be made of aluminum or an aluminum alloy. In some embodiments, because the second terminal 150 and the second collector 140 are made of the same metal, the second terminal 150 and the second collector 140 may be directly coupled by welding.

The case 160 may have an approximately hollow rectangular parallelepiped shape with openings 161 and 162 defined at both sides (or ends) thereof, and the electrode assembly 110, coupled to the first and second collectors 120 and 140, may be inserted into the case 160 through one or both of the openings 161 and 162.

The case 160 may have two long side surfaces in a rectangular shape, which connect (or extend between) top and bottom surfaces, extending in a second direction that is a longitudinal direction to a long side between the top and bottom surfaces, and extend in the second direction. In the case 160, the top and bottom surfaces and the two long side surfaces may be integrated with each other.

The case 160 may have a vent hole passing through the long side surface. A safety vent may be installed in the vent hole in the case 160. In some embodiments, the safety vent may be provided with a notch that is thinner than other areas to be opened (e.g., to burst) at a set (or reference) pressure.

The first cap assembly 170 may be coupled to a left opening 161 in the case 160. In some embodiments, the first cap assembly 170 may include a first cap plate 171, a first insulating member 172, a first seal gasket 173, and a first glue member 174.

The first cap plate 171 may have a flat rectangular plate shape to seal the left opening 161 in the case 160. The first cap plate 171 may have a terminal hole (or terminal opening) passing between an outer surface and an inner surface thereof and an electrolyte injection hole (or electrolyte injection opening). The projection 122b of the second collector plate 122 may pass through the terminal hole in the first cap plate 171 and may be coupled to the first terminal plate 131. In some embodiments, after the first cap plate 171 is coupled to the case 160, the electrolyte injection port may be sealed by a stopper after the electrolyte is injected into the case 160. In some embodiments, the stopper may be provided on the first cap plate 171 and/or the second cap plate 181, but in some embodiments, the structure in which the stopper 186 is provided on the second cap plate 181. The later embodiment will be described in more detail below.

The first insulating member 172 may be disposed between the inner surface of the first cap plate 171 and the first terminal plate 131. The first insulating member 172 may be in close contact with the inner surface of the first cap plate 171 and may also be in close contact with the first seal gasket 173. The first insulating member 172 may be made of an insulating material to insulate the first cap plate 171 and the first terminal plate 131 from each other.

In some embodiments, the first seal gasket 173 may be made of an insulating material and may be provided between the first cap plate 171 and the first terminal plate 131 or on the outer surface of the first terminal plate 131 to seal a gap between the first cap plate 171 and the first terminal plate 131. The first seal gasket 173 may prevent external moisture from penetrating into the secondary battery 100 or may prevent the electrolyte contained in the secondary battery 100 from leaking to the outside. The first seal gasket 173 may be manufactured with the first insulating member 172 in an insert molding method.

In some embodiments, the first cap plate 171 may be electrically separated from (or electrically isolated from) the first terminal 130 and the second collector plate 122 by the first insulating member 172 and the first seal gasket 173.

The second cap assembly 180 may be coupled to a right opening 162 in the case 160. In some embodiments, the second cap assembly 180 may include a second cap plate 181, a second insulating member 182, a second seal gasket 183, and a second glue member 184. The second cap assembly 180 may have the same shape and structure as the first cap assembly 170. In some embodiments, the coupling shape and structure of the second cap assembly 180 and the second terminal 150 may be the same as those of the first cap assembly 170 and the first terminal 130. However, the coupling shape of the second cap assembly 180 and the second terminal 150 may be symmetrical to the coupling shape of the first cap assembly 170 and the first terminal 130 with respect to the case 160.

In the secondary battery 100, the first cap assembly 170 coupled to the first terminal 130 may be coupled to an opening in one side of the case 160, and the second cap assembly 180 coupled to the second terminal 150 may be coupled to an opening in the other side of the case 160, and thus, the first terminal 130 and the second terminal 150 may be disposed at both sides (e.g., opposite sides or ends) of the case 160 with the case 160 being a center. The secondary battery 100 may be provided with the first terminal 130 and the second terminal 150 at opposite sides thereof, and thus, if a plurality of the secondary batteries 100 are coupled together in the form of a module, a cooling member may be coupled to each of the upper and lower areas of the case 160. In some embodiments, deterioration of the secondary battery 100 may be reduced by improving cooling performance.

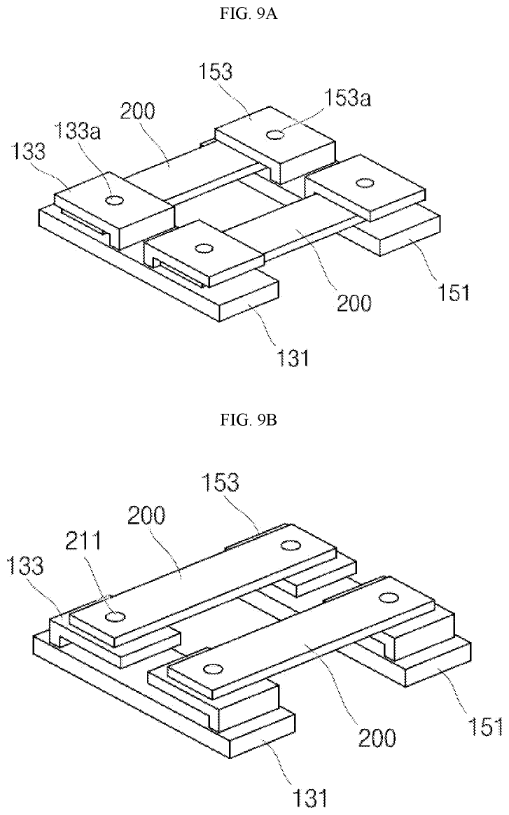

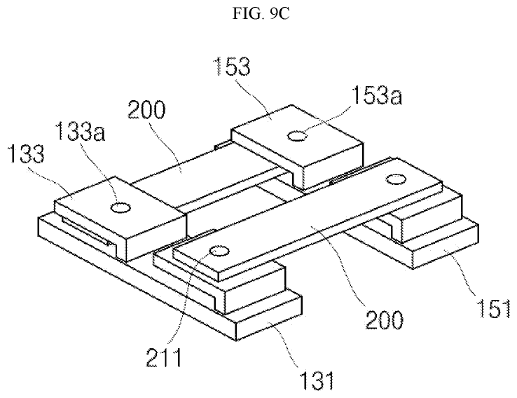

FIG. 8 is a perspective view of a battery module including a plurality of the secondary batteries shown in FIG. 1 according to embodiments, and FIGS. 9A to 9C are view of bent terminals of the battery module according to embodiments. Hereinafter, a battery module 1 in which the secondary batteries 100 are coupled together in the form of a module will be described with reference to FIGS. 8 and 9.

In some embodiments, in the state in which long side surfaces are disposed to face each other from among the plurality of secondary batteries 100, the first terminals 130 and/or the second terminals 150, which are respectively exposed to both sides, may be electrically connected to each other.

In some embodiments, the first terminal 130 and the second terminal 150 may be provided at both sides of the secondary battery 100, respectively. If the plurality of secondary batteries 100 are coupled together in the form of a module, charging/discharging current may flow along each of the terminals in both directions. In some embodiments, two terminals may be provided at opposite sides to improve deterioration compared to a secondary battery in which the charging/discharging current flows along two terminals at one side thereof. In some embodiments, if the plurality of secondary batteries 100 are coupled in the form of the module, space utilization may be improved because the respective terminals are connected to each other at both the sides.

Referring to FIG. 8, the battery module 1 may include the plurality of secondary batteries 100 and a busbar connecting the first terminal 130 to the second terminal 150 of the neighboring secondary batteries 100a and 100b.

In some embodiments, the battery module 1 may include a plurality of secondary batteries 100 including first and second terminals 130 and 150 provided with first and second protrusions 133 and 153 that protrude vertically to the outside of the first and second cap plates 171 and 181. In some embodiments, the battery module 1 may include a plurality of busbars 200 that electrically connect the first terminal 130 to the second terminal 150.

The busbar 200 may have a plate shape or a bar shape but is not limited thereto and may also be provided in a bent shape. In some embodiments, a thickness of the busbar 200 may be thinner than that of each of the first and second protrusions 133 and 153.

In some embodiments, the plurality of secondary batteries 100 may be arranged in a stacked manner and may be arranged to be stacked side-by-side in a lateral direction (e.g., the third direction or z direction) so that wide front surfaces of the secondary batteries 100a and 100b face each other.

The electrical connection between the plurality of secondary batteries 100 may be a series connection or a parallel connection or may be combination of the series connection and the parallel connection. However, in some embodiments, the plurality of secondary batteries 100 may be connected in series by the busbar 200.

When the plurality of secondary batteries 100 are connected in series, in a state in which positive and negative electrode terminals of the neighboring secondary batteries 100 are alternately disposed, the busbar 200 may be installed on the positive electrode terminal of one secondary battery 100 and the negative electrode terminal of the neighboring secondary battery 100. In some embodiments, for convenience of explanation, one secondary battery may be referred to as a first secondary battery 100a, and the secondary battery adjacent thereto may be referred to as a second secondary battery 100b.

In some embodiments, the busbar 200 may be coupled to the first terminal 130 of the first secondary battery 100a and the second terminal 150 of the second secondary battery 100b. In some embodiments, the first and second terminals 130 and 150 may include first and second protrusions 133 and 153, and the busbar 200 may be coupled to the first protrusion 133 of the first secondary battery 100a and the second protrusion 153 of the second secondary battery 100b. Each of the first and second protrusions 133 and 153 of the first and second terminals 130 and 150 may be made of a metal material, such as aluminum or copper, that is capable of be similarly welded to each busbar 200.

The busbar 200 may have a coupling area 210 disposed at each of both ends (or opposite ends) thereof and coupled to the first and second protrusions 133 and 153 and a connection area 220 disposed between the coupling areas 210. In some embodiments, a hole (or opening) 211 may be defined in the coupling areas 210 of the busbar 200. The busbar hole 211 may be defined to correspond to each of first and second guide holes 133a and 153a, respectively defined in central areas of the first and second protrusions 133 and 153. In some embodiments, the busbar 200 and the first and second protrusions 133 and 153 may be coupled to be matched at set positions by using the hole 211 defined in the busbar 200 and the first and second guide holes 133a and 153a in the first and second protrusions 133 and 153 as guide points.

In some embodiments, first welding areas 134 and 154 for welding with the busbar 200 may be disposed on the first and second protrusions 133 and 153. In some embodiments, the first and second protrusions 133 and 153 and the busbar 200 may be aligned and welded based on the first and second guide holes 133a and 153a of the first and second protrusions 133 and 153 and the hole 211 in the busbar 200.

In some embodiments, a welding process with the busbar 200 may be performed on outer surfaces of the first and second protrusions 133 and 153. In some embodiments, when the busbar 200 is coupled to the outer surfaces of the first and second protrusions 133 and 153, the welding process with the first and second protrusions 133 and 153 may be performed on a surface of the busbar 200. However, the preset disclosure is not limited thereto, and the busbar 200 may be coupled to a surface (e.g., an inner surface) on which two projections of the first and second protrusions 133 and 153 face each other. In some embodiments, the welding process with the busbar 200 may be performed on outer surfaces of the first and second protrusions 133 and 153.

In some embodiments, as described above, the first and second protrusions 133 and 153 may be bent (see, e.g., FIG. 7). In some embodiments, as illustrated in, for example, FIGS. 9A-9C, the first and second protrusions 133 and 153 may be welded to the busbar 200 and then bent in a direction of the first and second cap plates 171 and 181. In some embodiments, when the first and second protrusions 133 and 153 are bent, an insulator may be disposed between the first and second protrusions 133 and 153 according to a material or contact structure.

In some embodiments, the first and second protrusions 133 and 153 may be provided as at least two projections. In some embodiments, the busbar 200 may be at least two busbars which are connected to at least two projections, respectively. Hereinafter, an embodiment in which the first and second protrusions 133 and 153 are provided as two projections and the two busbars 200 are respectively connected to the two projections will be described as an example. In the embodiments shown in FIGS. 9A and 9B, the first and second terminal grooves 132 and 152 may be omitted, but they may be disposed between the two projections.

Referring to FIG. 9A, the first and second protrusions 133 and 153 may have two projections that are bent outwardly. In some embodiments, when both of the busbars 200 are coupled to the outer surfaces of the first and second protrusions 133 and 153, after being bent, the busbars 200 may be disposed below the first and second protrusions 133 and 153. In some embodiments, when both of the busbars 200 are coupled to the inner surfaces of the first and second protrusions 133 and 153, after being bent, the busbars 200 may be disposed above the first and second protrusions 133 and 153.

Referring to FIG. 9B, the first and second protrusions 133 and 153 may be bent in a direction in which the two projections face each other. In some embodiments, when both of the busbars 200 are coupled to the outer surfaces of the first and second protrusions 133 and 153, after being bent, the busbars 200 may be disposed above the first and second protrusions 133 and 153. In some embodiments, when both of the busbars 200 are coupled to the inner surfaces of the first and second protrusions 133 and 153, after being bent, the busbars 200 may be disposed below the first and second protrusions 133 and 153. When the two projections of the first and second protrusions 133 and 153 are bent in the directions facing each other, portions of the first and second protrusions 133 and 153 may overlap each other, different from the configuration illustrated in the drawings.

Referring to FIG. 9C, the first and second protrusions 133 and 153 may be bent so that the two projections face the same direction. In some embodiments, when both of the busbars 200 are coupled to the outer surfaces of the first and second protrusions 133 and 153, after being bent, the busbars 200 may be disposed above and below the first and second protrusions 133 and 153. When the two projections of the first and second protrusions 133 and 153 are bent in the same direction, portions of the first and second protrusions 133 and 153 may overlap each other, different from the configuration illustrated in the drawings.

In some embodiments, each of the first and second protrusions 133 and 153 may be provided as one projection (see, e.g., FIG. 6), and one busbar 200 may be connected to a projection of the first protrusion 133 and a projection of the second protrusion 153. In some embodiments, the busbar 200 may be coupled to one of both surfaces of one projection of the first and second protrusions 133 and 153. As a result, when each of the first and second protrusions 133 and 153 has only one projection, the busbar 200 may be bent to be disposed on bottom surfaces of the first and second protrusions 133 and 153 or may be bent to be disposed on top surfaces of the first and second protrusions 133 and 153.

In some embodiments, the first and second protrusions 133 and 153 are described above as being bent after being coupled to the busbar 200, but the first and second protrusions 133 and 153 may not be bent. However, in an embodiment in which the bending occurs, a thickness of each of the first and second protrusions 133 and 153 may be thinner than in an embodiment that does not include the bending to facilitate the bending process.

As described above, the first and second terminals 130 and 150 may be welded to the busbar 200 outside the first and second cap plates 171 and 181 by the first and second protrusions 133 and 153. In some embodiments, the welding may be performed on an outer surface of the busbar 200. Therefore, in some embodiments, because the welding area is exposed to the outside, a shape of a welding bead may be directly confirmed from the outside, and thus, welding quality may be easily checked, and a non-destructive inspection (e.g., CT or shearography) process of a welded part may be replaced with vision inspection and low resistance testing. In some embodiments, laser welding may be performed between the first and second protrusions 133 and 153 and the busbar 200 in a module/pack process, and also, a bead shape may be sensed (or detected) through upper and lower visual inspection to achieve detection power in a flawless level.

According to embodiments of the present disclosure, the protrusion terminal may be provided to perform the welding with the busbar at the protruding portion, and thus, the shape of the welding bead may be directly confirmed to improve the weldability of the terminal and the busbar and secure weak/non-welding detection performance.

In addition, according to various embodiments of the present disclosure, the shape of the welding bead may be directly confirmed, and thus, it may be easy to check the welding quality, and a CT or shearography process may be replaced with the vision inspection, etc.

The above-described embodiments are merely embodiments of the secondary battery, and thus, the present disclosure is not limited to the foregoing embodiments. Also, it will be understood by those of ordinary skill in the art that various changes in form and details may be made therein without departing from the spirit and scope of the present invention as defined by the following claims and their equivalents.

1 what is claimed is:

1. A secondary battery comprising:
an electrode assembly comprising a first electrode tab and a second electrode tab exposed at opposite sides thereof;
a first collector electrically coupled to the first electrode tab;
a case having two open sides and accommodating the electrode assembly and the first collector therein;
a first cap plate sealing one of the open sides of the case; and
a first terminal mechanically and electrically coupled to the first collector and exposed to the outside of the first cap plate, the first terminal comprising:
a first terminal plate at a side of the first collector; and
a first protrusion vertically protruding from a top surface of the first terminal plate to the outside of the first cap plate.

2. The secondary battery as claimed in claim 1, wherein the first protrusion is one projection.

3. The secondary battery as claimed in claim 1, wherein the first protrusion comprises a plurality of projections.

4. The secondary battery as claimed in claim 3, wherein the projections have the same shape.

5. The secondary battery as claimed in claim 1, wherein the first protrusion is bent in a direction of the first cap plate.

6. The secondary battery as claimed in claim 1, wherein a guide hole is defined in a central area of the first protrusion.

7. The secondary battery as claimed in claim 1, wherein the first terminal plate has a square shape or a circular shape.

8. The secondary battery as claimed in claim 1, wherein the first terminal plate has a groove for welding with the first collector.

9. The secondary battery as claimed in claim 1, wherein the first protrusion has a protruding length in a range of about 15 mm to about 50 mm.

10. A battery module comprising:
a first secondary battery and a second secondary battery adjacent to each other and having the same structure; and
a busbar electrically connecting the first and second secondary batteries to each other,
wherein each of the first secondary battery and the second secondary battery comprises:
an electrode assembly comprising a first electrode tab and a second electrode tab exposed to opposite sides thereof;
first and second collectors electrically coupled to the first and second electrode tabs, respectively;
a case accommodating the electrode assembly and the first and second collectors, the case having opposite open sides;
a first cap plate sealing one of the open sides of the case and a second cap plate sealing an opening of the other one of the open sides of the case; and
first and second terminals mechanically and electrically coupled to the first and second collectors and exposed to the outside of the first and second cap plates, respectively, the first and second terminals respectively comprising first and second terminal plates at sides of the first and second collectors and first and second protrusions vertically protruding from top surfaces of the first and second terminal plates to the outside of the first and second cap plates,
wherein the busbar is coupled to the first protrusion of the first secondary battery and the second protrusion of the second secondary battery.

11. The battery module as claimed in claim 10, wherein the busbar has coupling areas at opposite ends thereof and respectively coupled to the first and second protrusions and a connection area between the coupling areas.

12. The battery module as claimed in claim 11, wherein each of the first and second protrusions has a guide hole in a central area thereof, and
wherein each of the coupling areas of the busbar has a hole to correspond to the guide hole in each of the first and second protrusions.

13. The battery module as claimed in claim 11, wherein each of the first and second protrusions has a welding area for welding with the coupling area of the busbar.

14. The battery module as claimed in claim 10, wherein the welding process of the busbar is performed on outer surfaces of the first and second protrusions.

15. The battery module as claimed in claim 10, wherein each of the first and second protrusions is one projection, and
wherein the busbar is connected to and extends between a projection of the first protrusion and a projection of the second protrusion.

16. The battery module as claimed in claim 15, wherein the first and second protrusions are bent in a direction of the first and second cap plate, respectively, and
wherein the busbar is bent to be on bottom surfaces of the first and second protrusions or the busbar is bent to be on top surfaces of the first and second protrusions.

17. The battery module as claimed in claim 10, wherein each of the first and second protrusions comprises a plurality of projections, and
wherein the busbar comprises a plurality of busbars connected to the projections of the first protrusion and to the projections of the second protrusion, respectively.

18. The battery module as claimed in claim 17, wherein at least one of the busbars is coupled to a surface opposite to a surface on which the projections of the first and second protrusions face each other.

19. The battery module as claimed in claim 17, wherein, after the first and second protrusions and the busbar are welded, the first and second protrusions are bent toward the first and second cap plate, respectively.

20. The battery module as claimed in claim 19, wherein the first and second protrusions are bent in a direction in which the projections face each other.

21. The battery module as claimed in claim 19, wherein the projections of the first and second protrusions are bent outwardly.

22. The battery module as claimed in claim 19, wherein the projections of the first and second protrusions are bent in the same direction.

23. The battery module as claimed in claim 10, wherein the first secondary battery and the second secondary battery are connected in series or parallel through the busbar.

24. The battery module as claimed in claim 10, wherein the first protrusion has a protruding length in a range of 15 mm to 50 mm.
